(19) United States
(12) Patent Application Publication
(10) Pub. No.: US 2014/0227628 A1
(43) Pub. Date: Aug. 14, 2014

(54) Redox Flow Battery Stack and Redox Flow Battery System Having the Same

(71) Applicants: Hao Tang, Chengdu (CN); cn Xie, Chengdu (CN); Cong Yin, Chengdu (CN); Ronggui Wang, Chengdu (CN); Yuncheng Hu, Chengdu (CN)

(72) Inventors: Hao Tang, Chengdu (CN); cn Xie, Chengdu (CN); Cong Yin, Chengdu (CN); Ronggui Wang, Chengdu (CN); Yuncheng Hu, Chengdu (CN)

(73) Assignee: Dongchang Electric Corporation, Chengdu, Sichuan (CN)

(21) Appl. No.: 14/235,691

(22) PCT Filed: Nov. 25, 2011
(86) PCT No.: PCT/CN2011/082981

§ 371 Date: Jan. 28, 2014

(30) Foreign Application Priority Data
Aug. 1, 2011 (CN) 201110218475.4

(51) Int. Cl. H01M 8/20; H01M 8/18

(52) U.S. Cl. CPC H01M 8/20; H01M 8/188
USPC 429/498

(57) ABSTRACT

The disclosure discloses a redox flow battery stack and a redox flow battery system having the same, wherein the redox flow battery stack includes: flow frames, flow plates arranged inside the flow frame, ion exchange membranes arranged between the flow plates and forming a cavity for accommodating electrolyte with the flow plate, and electrodes arranged inside the cavity, wherein two groups of flow ports are provided on the sides of the flow frame, each group of flow ports includes: a liquid inlet and a liquid outlet, and the liquid inlet and the liquid outlet in each group of flow ports are provided in the manner of one-to-one correspondence and are interconnected with a corresponding cavity; the redox flow battery stack further includes: electrolyte pipelines, the liquid inlet and the liquid outlet in each group of flow ports respectively have a corresponding electrolyte pipeline and interconnect with the corresponding electrolyte pipeline. The disclosure provides a redox flow battery stack, with simple assembly, simple follow-up operation of maintenance and low cost, and provides a redox flow battery system having the redox flow battery stack, thereby effectively solving the problems of complex assembly and complex follow-up operation of maintenance in the conventional art.

### TECHNICAL FIELD OF THE INVENTION

The disclosure relates to the field of redox flow battery, in particular to a redox flow battery stack and a redox flow battery system having the same.

### BACKGROUND OF THE INVENTION

There are many types of redox flow batteries. Taking the widely used all-vanadium redox flow battery for example, it is an electrochemical apparatus which uses vanadium ion electrolyte with different valences to perform oxidation reduction, and can efficiently realize the reciprocal transformation between chemical energy and electric energy. This kind of battery has advantages of long service life, high efficiency of energy transformation, high security and environmentally friendliness, and can be applied to a large-scale stored energy system matched with wind power and photovoltaic power, and is one of the main choices for peak load shifting and load balancing of the power grid. Therefore, the all-vanadium redox flow battery becomes the focus of research on the high-capacity storage battery gradually in recent years.

The all-vanadium redox flow battery takes V²⁺/V³⁺ and V⁴⁺/V⁵⁺ as the oxidation-reduction pair of positive and negative electrodes of the battery, wherein the positive electrolyte and the negative electrolyte are stored in two reservoirs respectively to be pumped into the battery by a pump, and then return to the reservoirs to form a closed circulating flow loop, to realize the charge and discharge process.

In an all-vanadium redox flow battery system, the performance of a battery stack determines the charge and discharge performance of the whole system, particularly the power and the efficiency of charge and discharge. The battery stack is formed by a plurality of single batteries which are stacked and compacted successively and are connected in series, Wherein, a conventional single redox flow battery and a battery stack are shown in FIG. 1. The single redox flow battery includes: a flow frame 1, a flow plate 2, an electrode 3 and an ion exchange membrane 4; a battery stack 5 is formed by stacking and compacting a plurality of single batteries successively which are connected in series.

In the present redox flow battery stack, a main flow passage is formed by stacking and compacting successively the corresponding flow holes on the parts such as the flow frame; generally, the main flow direction is perpendicular to the plane of the flow frame and the flow plate. The main flow passage generally is divided into a positive electrolyte flow passage and a negative electrolyte flow passage, wherein both the positive and negative electrolyte flow passages include a liquid inlet passage and a liquid outlet passage. The two liquid inlet passages, including the positive liquid inlet passage and the negative liquid inlet passage, and the two liquid outlet passages, including the positive liquid outlet passage and the negative liquid outlet passage, are arranged at four corners of a rectangular (including square) flow frame; in addition, the positive liquid inlet passage and the negative liquid inlet passage are arranged adjacently; the positive liquid inlet passage and the positive liquid outlet passage are arranged at a diagonal; the negative liquid inlet passage and the negative liquid outlet passage are arranged at a diagonal.

Because of the conventional design mode, it is more difficult to operate in the assembly process; besides, it is complex to maintain or replace later. Once a local sealing problem appears, the whole redox flow battery stack has to be detached for treatment, thus it is very inconvenient.

Meanwhile, the flow passage in the art needs to punch holes on the flow plate and the ion exchange membrane; thus, on one aspect, the difficulty of processing and assembling is enhanced, on the other aspect, the flow plate and the ion exchange membrane with high cost have a low utilization ratio; therefore, the cost of the battery stack rises.

### SUMMARY OF THE INVENTION

The purpose of the disclosure is to provide a redox flow battery stack, with simple assembly, simple follow-up operation of maintenance or replacement, and lower cost, and provides a redox flow battery system having the redox flow battery stack.

In order to achieve the purpose above, according to one aspect of the disclosure, a redox flow battery stack including: flow frames; flow plates arranged inside the flow frames; ion exchange membranes arranged between the flow plates and forming a cavity for accommodating electrolyte with the flow plate ; and electrodes arranged inside the cavity; wherein, two groups of flow ports are provided on the sides of the flow frame, each group of flow ports includes: a liquid inlet and a liquid outlet, and the liquid inlet and the liquid outlet in each group of flow ports are provided in the manner of one-to-one correspondence and are interconnected with a corresponding cavity; the redox flow battery stack further includes: electrolyte pipelines, the liquid inlet and the liquid outlet in each group of flow ports respectively have a corresponding electrolyte pipeline and interconnect with the corresponding electrolyte pipeline.

Further, the redox flow battery stack further includes: sealing elements arranged at the connection position between the liquid inlet and the liquid outlet in each group of flow ports and the corresponding electrolyte pipelines.

Further, the electrolyte pipeline includes: a main pipeline, interconnected with a container storing the electrolyte; and a branch pipeline, arranged between the main pipeline and the flow port of the flow frame.

Further, each electrolyte pipeline includes a plurality of branch pipelines, all of which are parallel to each other, and the distance between the branch pipelines is equal to that between the flow frames.

Further, the main pipeline is a rigid pipeline or a flexible pipeline.

Further, the branch pipeline is a rigid pipeline or a flexible pipeline.

Further, the main pipeline and/or the branch pipeline are bent.

Further, the liquid inlet and the liquid outlet in each group of flow ports are arranged on the opposite sides of the flow frame.

Further, the axis of the liquid inlet and the axis of the liquid outlet are parallel to each other.

According to another aspect of the disclosure, a redox flow battery system, including a redox flow battery stack, an electrolyte container and a pump, the electrolyte container is interconnected with the flow frame of the redox flow battery stack through the pump, wherein, the redox flow battery stack includes: flow frames; flow plates arranged inside the flow frames; ion exchange membranes arranged between the flow plates and forming a cavity for accommodating electrolyte with the flow plate; and electrodes arranged inside the cavity; wherein, two groups of flow ports are provided on the sides of the flow frame, each group of flow ports includes: a liquid inlet and a liquid outlet, and the liquid inlet and the liquid outlet in each group of flow ports are provided in the manner of one-to-one correspondence and are interconnected with a corresponding cavity; the redox flow battery stack further includes: electrolyte pipelines, the liquid inlet and the liquid outlet in each group of flow ports respectively have a corresponding electrolyte pipeline and interconnect with the corresponding electrolyte pipeline.

Further, the redox flow battery system is an all-vanadium redox flow battery system.

Further, the redox flow battery stack further includes: sealing elements arranged at the connection position between the liquid inlet and the liquid outlet in each group of flow ports and the corresponding electrolyte pipelines.

Further, the electrolyte pipeline includes: a main pipeline, interconnected with a container storing the electrolyte; and a branch pipeline, arranged between the main pipeline and the flow port of the flow frame.

Further, each electrolyte pipeline includes a plurality of branch pipelines, all of which are parallel to each other, and the distance between the branch pipelines is equal to that between the flow frames.

Further, the main pipeline is a rigid pipeline or a flexible pipeline.

Further, the branch pipeline is a rigid pipeline or a flexible pipeline.

Further, the main pipeline and/or the branch pipeline are bent.

Further, the liquid inlet and the liquid outlet in each group of flow ports are arranged on the opposite sides of the flow frame.

Further, the axis of the liquid inlet and the axis of the liquid outlet are parallel to each other.

In the technical scheme of the disclosure, the sides of the flow frame are provided with two groups of flow ports, each group of flow ports includes: a liquid inlet and a liquid outlet, and the liquid inlet and the liquid outlet in each group of flow ports are provided in the manner of one-to-one correspondence and are interconnected with a corresponding cavity. The battery stack in this disclosure is further provided with electrolyte pipelines, wherein the electrolyte pipeline is arranged outside the flow frame and is interconnected with the liquid inlet and the liquid outlet in each corresponding group of flow ports respectively. The electrolyte pipeline needs to be sealed with the flow port by the structure thereof or by a seal ring. Since sealing is conducted between the electrolyte pipeline and each flow port respectively, in the follow-up process of maintenance or replacement, only the aged or damaged sealing part needs to be maintained or replaced. In this way, the follow-up operation of maintenance becomes simple. Meanwhile, since the flow port is arranged on the side of the flow frame, no holes need to be punched on the flow plate or the ion exchange membrane. Further, the difficulty of processing and assembling is reduced, and the cost of the battery stack is reduced.

### BRIEF DESCRIPTION OF THE DRAWINGS

For a better understanding of the disclosure, accompanying drawings described hereinafter are provided to constitute one part of the application; the schematic embodiments of the disclosure and the description thereof are used to illustrate the disclosure but to limit the disclosure improperly, In the accompanying drawings:

FIG. 1 shows a structure diagram of a redox flow battery and a redox flow battery stack in the art;

FIG. 2 shows a structure diagram of the first embodiment of a redox flow battery stack according to the disclosure;

FIG. 3 shows a structure diagram of a single battery of the first embodiment of the redox flow battery stack shown in FIG. 2;

FIG. 4a shows an A-A sectional diagram of the single battery shown in FIG. 3, not including an ion exchange membrane;

FIG. 4b shows a B-B sectional diagram of the single battery shown in FIG. 3, not including an ion exchange membrane;

FIG. 5 shows a stereo structure diagram of a redox flow pipeline of the first embodiment of the redox flow battery stack shown in FIG. 2;

FIG. 6 shows a sectional diagram of the redox flow pipeline shown in Fig,

FIG. 7 shows a structure diagram of the second embodiment of a redox flow battery stack according to the disclosure; and

FIG. 8 shows a structure diagram of the third embodiment of a redox flow battery stack according to the disclosure.

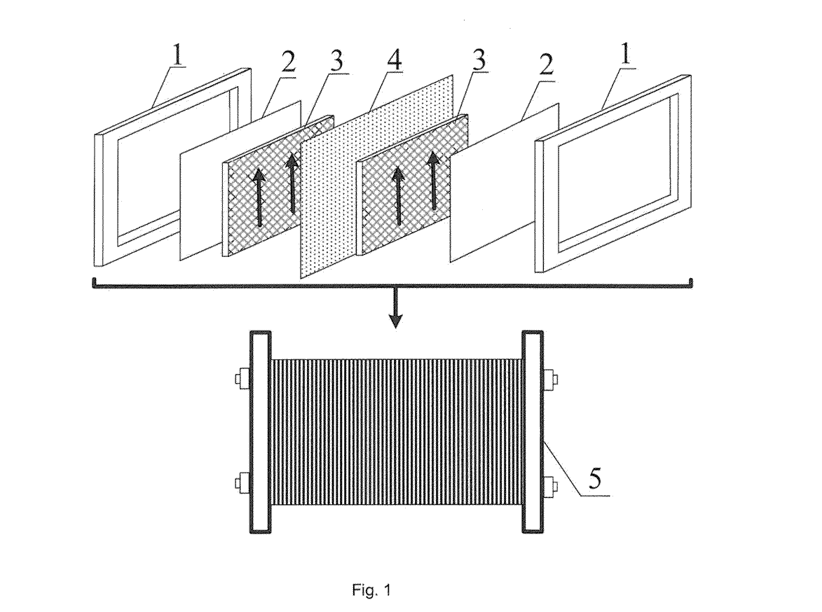

### DETAILED DESCRIPTION OF THE EMBODIMENTS

It should be noted that the embodiments in the application and the characteristics of the embodiments can be combined if no conflict is caused. The disclosure is described below in detail by reference to the accompanying drawings in conjunction with embodiments.

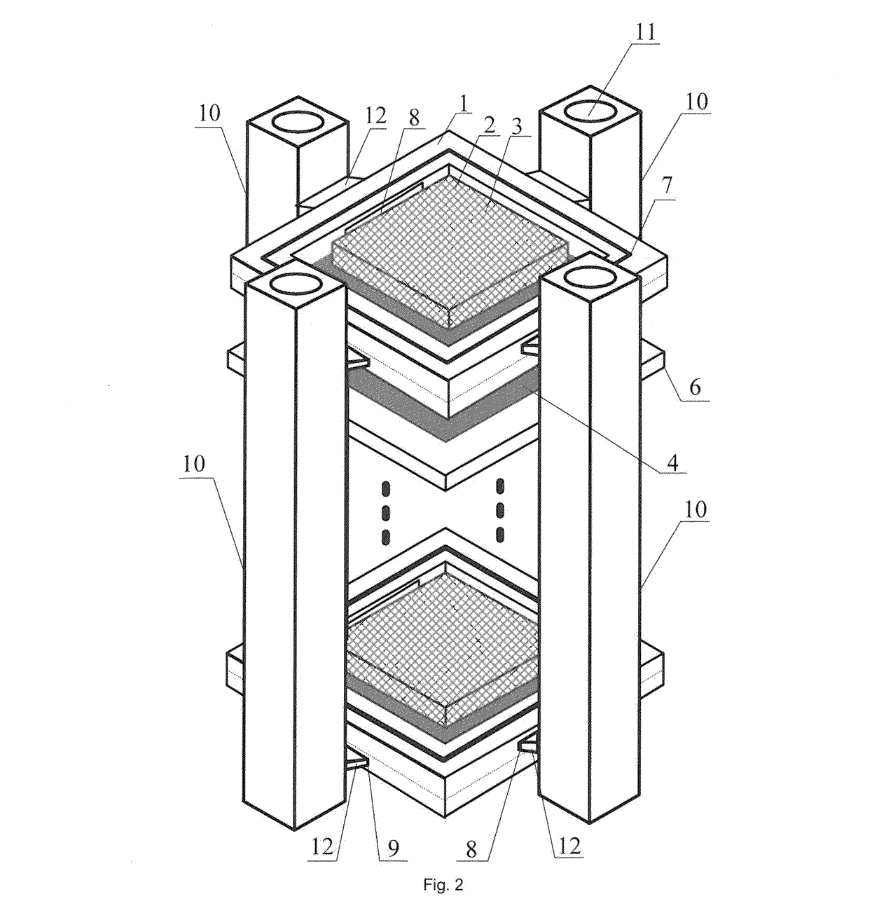

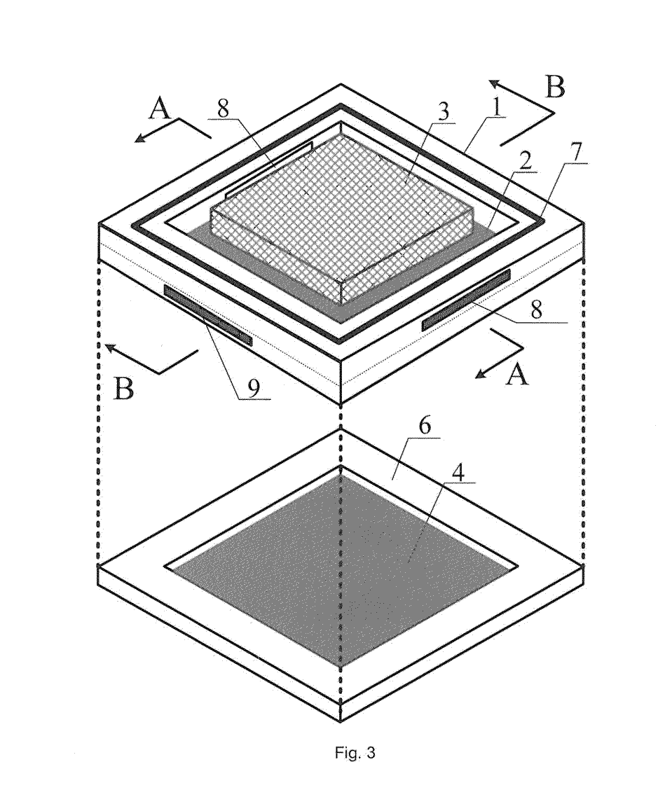

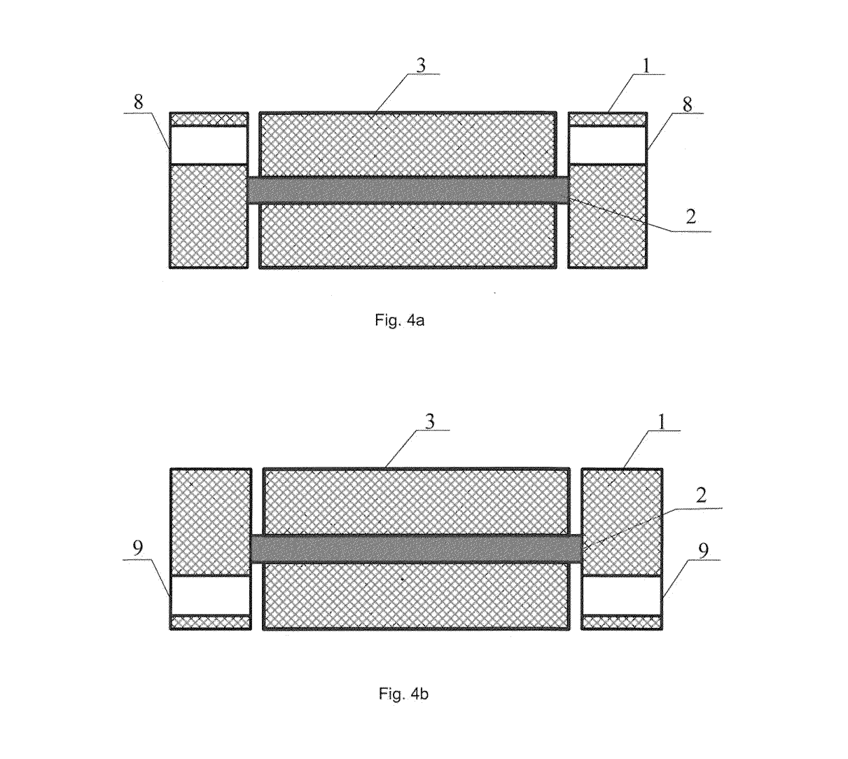

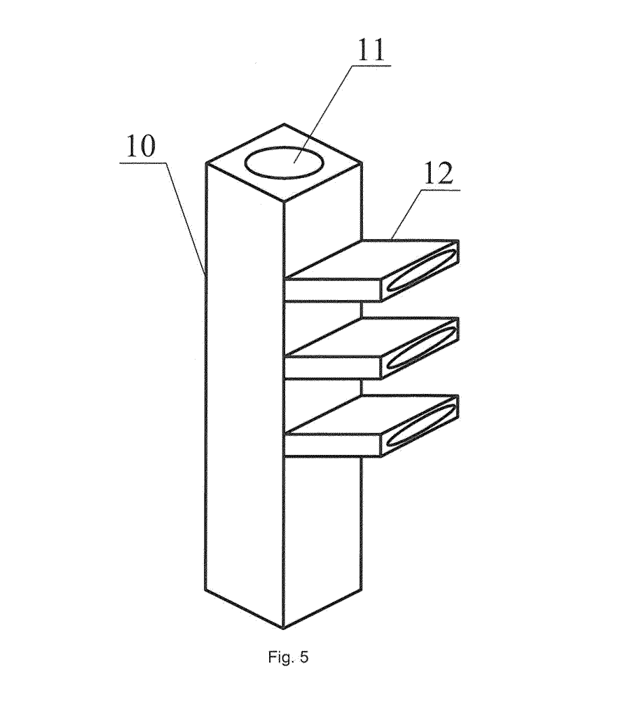

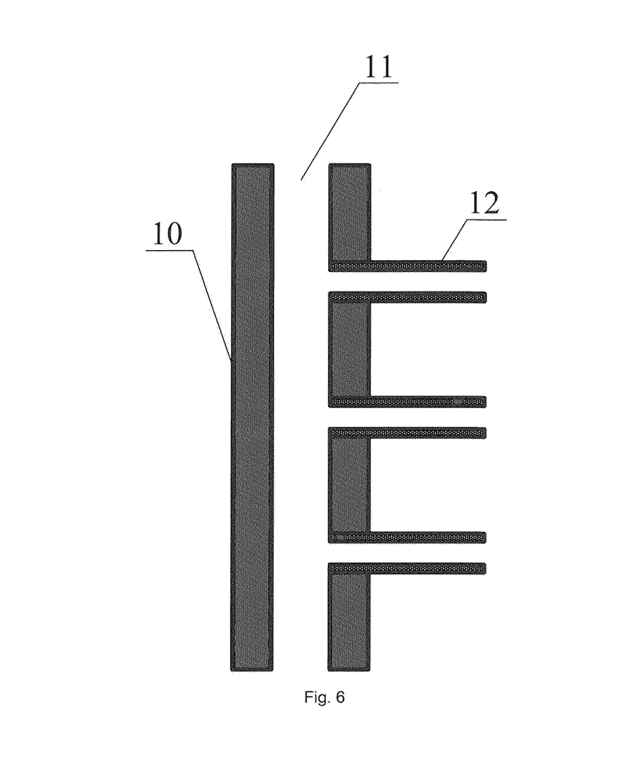

FIG. 2 shows a structure diagram of the first embodiment of a redox flow battery stack according to the disclosure; FIG. 3 shows a structure diagram of a single battery of the first embodiment of the redox flow battery stack shown in FIG. 2; FIG. 4a shows an A-A sectional diagram of the single battery shown in FIG. 3, not including an ion exchange membrane; FIG. 4b shows a B-B sectional diagram of the single battery shown in FIG. 3, not including an ion exchange membrane; FIG. 5 shows a stereo structure diagram of a redox flow pipeline of the first embodiment of the redox flow battery stack shown in FIG. 2; FIG. 6 shows a sectional diagram of the redox flow pipeline shown in FIG. 5.

As shown in FIGS. 2 and 3, a single battery of a redox flow battery stack in the first embodiment includes: a flow frame 1, a flow plate 2, an electrode 3, an ion exchange membrane 4, a diaphragm frame 6, a seal ring 7, flow ports 8 and flow ports 9. The flow plate 2 and the porous electrode 3 are integrated and then arranged inside the flow frame 1; the ion exchange membrane 4 is arranged inside the diaphragm frame 6; the flow frame 1 and the diaphragm frame 6 are compacted and sealed by the seal ring 7, so that a cavity for accommodating electrolyte is formed between the exchange membrane 4 and the flow plate 2. The single battery shown in FIG. 3 includes the flow frame 1, the diaphragm frame 6, the flow plate 2 and the porous electrode 3 arranged inside the flow frame 1, and the exchange membrane 4 arranged inside the diaphragm frame 6. The redox flow battery stack of the first embodiment is shown in FIG. 2, the redox flow battery stack is formed by duplication and lamination of the structure above.

As shown in FIG. 2 to FIG. 4b, the sides of the flow frame 1 of the redox flow battery stack of the first embodiment are provided with two groups of flow ports, each group of flow ports 8 and flow ports 9 includes a liquid inlet and a liquid outlet; and as shown in FIG. 4a and FIG. 4b, the liquid inlet and the liquid outlet in each group of flow ports 8 and flow ports 9 are provided in the manner of one-to-one correspondence and are interconnected with a corresponding cavity.

As shown in FIG. 2, the redox flow battery stack further includes: electrolyte pipelines, which are arranged outside the flow frame 1. The liquid inlet and the liquid outlet in each group of flow ports 8 and flow ports 9 respectively have a corresponding electrolyte pipeline, and interconnect with the corresponding electrolyte pipeline.

In the first embodiment, the seal between the electrolyte pipeline and the flow port 8/the flow port 9 depends on the structure itself or a seal ring. In this way, the problem of complex sealing process in the art is effectively solved. Since sealing is conducted between the electrolyte pipeline and each flow port respectively, in the follow-up process of maintenance or replacement, only the aged or damaged sealing part needs to be maintained or replaced. In the process, it is not necessary to detach and reassemble the structures, such as the flow frame 1, the flow plate 2, the electrode 3 and the ion exchange membrane 4. Thus, it is simple to operate the process of maintenance and replacement. In addition, since the flow port 8 and the flow port 9 are arranged on the sides of the flow frame 1, no holes need to be punched on the flow plate 2 and the ion exchange membrane 4. Further, the difficulty of processing and assembling is reduced and the cost of the battery stack is reduced.

In a preferred embodiment, as shown in FIG. 2, the liquid inlet and the liquid outlet of the flow port 8 are arranged on two opposite sides of the flow frame 1, and the liquid inlet and the liquid outlet of the flow port 9 are arranged on another two opposite sides of the flow frame 1. Thus, the size of the liquid inlet and the liquid outlet can be increased, even close, to the length of the side of the flow frame 1, so as to effectively accelerate the flow rate of the electrolyte, accordingly the reaction speed is accelerated, and additionally the efficiency of charge and discharge is improved.

Preferably, in the structure above, the axis of the liquid inlet and the axis of the liquid outlet are parallel to each other. Preferably, the liquid inlet and the liquid outlet are arranged at the diagonal position of the flow frame. Thus in the flowing process of the electrolyte from the liquid inlet to the liquid outlet, it is easy to cover more reaction regions to avoid the polarization problem caused by uneven reaction to some extent.

Preferably, the redox flow battery stack above further includes: sealing elements, which are arranged at the connection position between the liquid inlet and the liquid outlet in each group of flow ports 8, 9 and the corresponding electrolyte pipelines. Wherein, the sealing material used by the sealing element could be various materials that can be obtained by the person skilled in the art who uses the basic knowledge known.

Preferably, as shown in FIG. 5 and FIG. 6, the electrolyte pipeline includes: a main pipeline 11 and branch pipelines 12 connected with the main pipeline 11. The main pipeline 11 is used for interconnecting with a container storing electrolyte; the branch pipeline 12 is arranged between the main pipeline 11 and the flow port of the flow frame 1. In this embodiment, the main pipeline 11 is supported by a bracket 10. The main pipeline 11 and the branch pipeline 12 could be connected fixedly, also could be connected in a partially or completely detachable manner. The material of the parts above could be any material capable of satisfying the used environment of the redox flow battery system. According to different requirements of the selected material, the assembly condition and the pipeline design, the main pipeline 11 and the branch pipeline 12 could be of a rigid structure or a non-rigid structure.

Preferably, both the main pipeline 11 and the branch pipeline 12 are rigid pipelines. The structure above also can be used for assembling the battery stack while inputting/outputting electrolyte. Besides, in order to reduce the by-pass current and the consumption of liquid pump, and to optimize energy efficiency, the length of the branch pipeline 12 could be prolonged properly, or the pipe diameter thereof could be increased properly.

Preferably, in the redox flow battery stack above, each electrolyte pipeline includes a plurality of branch pipelines 12, all of which are parallel to each other, and the distance between the branch pipelines 12 is equal to that between the flow frames 1. Specifically, the distance between two adjacent branch pipelines 12 is equal to that between two adjacent flow frames 1 which are compacted and sealed.

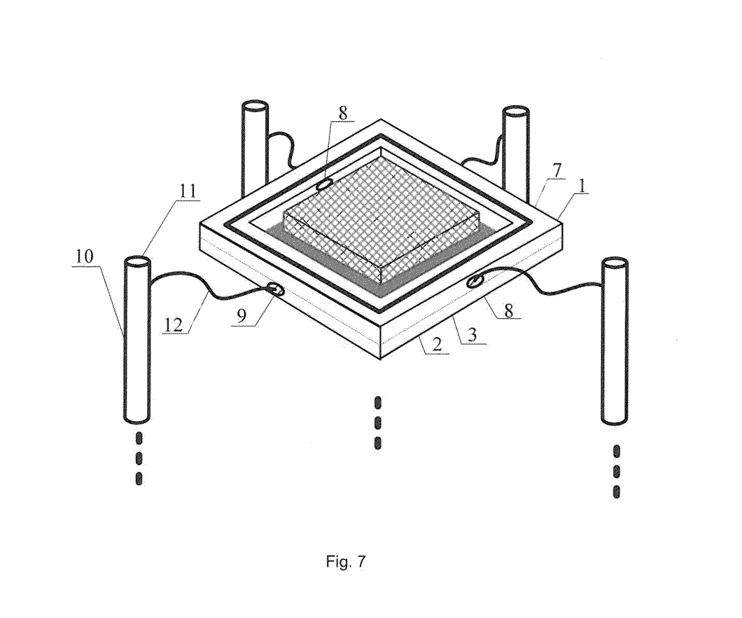

As shown in FIG. 7, the difference between the redox flow battery stack in the second embodiment and the redox flow battery stack in the first embodiment lies in that both the main pipeline 11 and the branch pipeline 12 are flexible pipelines, wherein the flexible pipeline is a hosepipe. The angle and the distance between the main pipeline 11 and the branch pipeline 12 are changeable; in addition, the distance between two adjacent branch pipelines 12 need not to be designed precisely. In the second embodiment, the main pipeline 11 and the branch pipeline 12 only take charge of the transportation of electrolyte; the assembling and sealing of the battery stack could be realized by pressurizing between a common bolt and an end plate. Besides, in order to reduce the by-pass current and the consumption of liquid pump, and to optimize energy efficiency, the length of the branch pipeline 12 could be prolonged properly, or the pipe diameter could be increased properly.

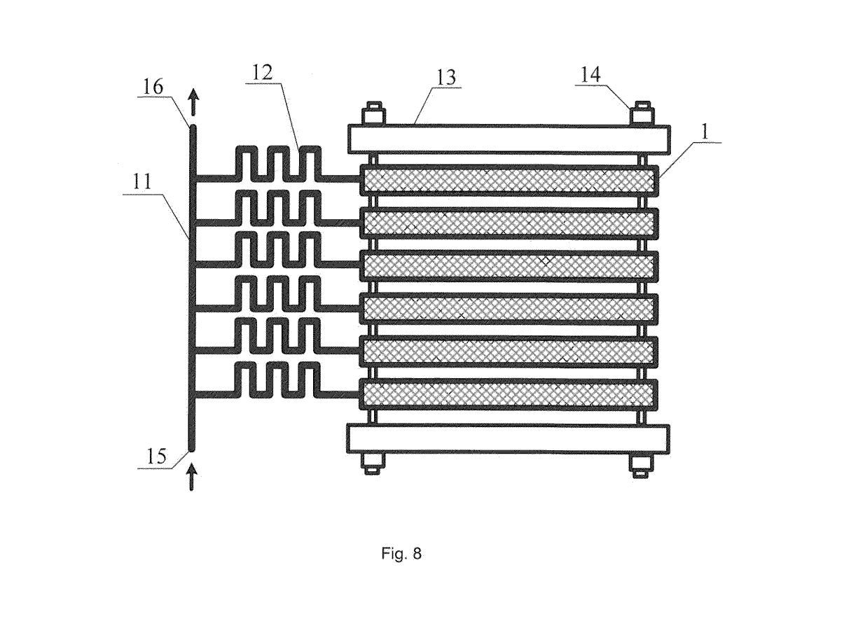

As shown in FIG. 8, in the third embodiment, the main pipeline 11 and the branch pipeline 12 in the redox flow battery stack are in a detachable connection. By means of the design of the main pipeline 11 or the branch pipeline 12, and the adjustment of parameters such as the flow length between adjacent single batteries or battery stacks, the pipeline material (different materials have different damping) and the size of pipe diameter, the uniformity of the flow rate between adjacent single batteries or battery stacks is realized, and the by-pass current of the battery stack is reduced. Specifically, the design is to adjust the flow length, to make the main pipeline 11 circuitous, and to provide the branch pipeline 12 (not shown in the drawings) at a proper position; or, as shown in FIG. 8, the main pipeline 11 adopts the design of a direct pipe while the branch pipeline 12 adopts the design of a bending circuitous pipe; or the main pipeline 11 and the branch pipeline 12 simultaneously adopt a circuitous design (not shown in the drawings). By means of comprehensively coordinating the flow rate and the flow length between single batteries, which are obtained by each single battery, the branch resistance between single batteries or battery stacks is effectively increased, the by-pass current is reduced, and the energy efficiency is optimized.

The disclosure further provides a redox flow battery system, which includes: a redox flow battery stack, an electrolyte container and a pump, wherein the electrolyte container is interconnected with the flow frame 1 of the redox flow battery stack through the pump, and the redox flow battery stack is the redox flow battery stack above-mentioned. Preferably, the redox flow battery system is an all-vanadium redox flow battery system.

From the description above, it can be seen that the above embodiments of the disclosure realizes the following technical effects:

1. The flow pipeline is arranged outside the flow frame, thus the designability of the battery stack is higher. According to different design requirements of each item, corresponding design parameters of the flaw pipeline and/or the main parts of the battery stack (the flow frame, the diaphragm frame, the flaw plate and the electrode arranged inside the flow frame, and the ion exchange membrane arranged, inside the diaphragm frame, etc) are adjusted separately to optimize the performance of the battery system. The design idea of the redox flow battery stack could be extended to the design of a large-scale storage battery module; the separate design of the electrolyte pipeline is convenient for the integration and assembly of the large-scale battery module.

2. The sealing structure between the flow frames inside the battery stack is simple; and it is convenient to be assembled with fewer components. The charge/discharge polarization is small, and the energy efficiency is high.

3. The waste of the flow plate is reduced effectively, thus the design of the flow plate is simpler and more feasible.

4. The scheme of the redox flow battery can reduce the by-pass current by means of proper design of the flow pipeline: besides, there is a detachable connection between the flow pipeline and the flow frame, the main pipeline and the branch pipeline, and the internal of the battery stack, for the convenience of the management and maintenance of the battery stack.

To design an all-vanadium redox flow battery by means of the technical scheme of the disclosure, examples are provided below.

### EXAMPLE 1

Select a high-conductivity porous graphite felt as the electrode material, a graphite plate as the flow plate, a Nafion membrane as the on exchange membrane, and use the battery pack to manufacture an all-vanadium redox flow battery system having a novel structure design under the guide of the first embodiment of the disclosure. The coulomb efficiency of charge and discharge of the battery system is 87.2%, the voltage efficiency is 86.7% and the energy efficiency is 75.6%.

### EXAMPLE 2

Select a high-conductivity porous graphite felt as the electrode material and a graphite plate as the flow plate, and design a parallel flow passage of the graphite plate. Use a Nation membrane as the ion exchange membrane, and use the battery pack to manufacture an all-vanadium redox flow battery system having a novel structure design under the guide of the first embodiment of the disclosure. The coulomb efficiency of charge and discharge of the battery system is 87.3%, the voltage efficiency is 88.3% and the energy efficiency is 77.1%.

### EXAMPLE 3

Select a high-conductivity porous graphite felt as the electrode material and a graphite plate as the flow plate, use a Nafion membrane as the ion exchange membrane, and use the battery pack to manufacture an all-vanadium redox flow battery system having a novel structure design under the guide of the second embodiment of the disclosure. The coulomb efficiency of charge and discharge of the battery system is 90.1%, the voltage efficiency is 85.3% and the energy efficiency is 76.9%.

### EXAMPLE 4

Select a high-conductivity porous graphite felt as the electrode material and a graphite plate as the flow plate, and design a parallel flow passage of the graphite plate; use a Nation membrane as the ion exchange membrane, and use the battery pack to manufacture an all-vanadium redox flow battery system having a novel structure design under the guide of the third embodiment of the disclosure. The coulomb efficiency of charge and discharge of the battery system is 92.3%, the voltage efficiency is 89.1% and the energy efficiency is 82.2%.

The above is only the preferred embodiment of the disclosure and not intended to limit the disclosure, For those skilled in the art, various modifications and changes can be made to the disclosure. Any modification, equivalent substitute and improvement made within the spirit and principle of the disclosure are deemed to be included within the protection scope of the disclosure.

1. A redox flow battery stack comprising:
flow frames (1);
flow plates (2) arranged inside the flow frames (1);
ion exchange membranes (4) arranged between the flow plates (2) and forming a cavity for accommodating electrolyte with the flow plate (2) ; and
electrodes (3) arranged inside the cavity;
wherein, two groups of flow ports are provided on the sides of the flow frame (1), each group of flow ports (8, 9) comprises: a liquid inlet and a liquid outlet, and the liquid inlet and the liquid outlet in each group of flow ports (8, 9) are provided in the manner of one-to-one correspondence and are interconnected with a corresponding cavity;
the redox flow battery stack further comprises:
electrolyte pipelines, the liquid inlet and the liquid outlet in each group of flow ports (8, 9) respectively have a corresponding electrolyte pipeline and interconnect with the corresponding electrolyte pipeline.

2. The redox flow battery stack according to claim 1, further comprising:
sealing elements arranged at the connection position between the liquid inlet and the liquid outlet in each group of flow ports (8, 9) and the corresponding electrolyte pipelines.

3. The redox flow battery stack according to claim 1, wherein the electrolyte pipeline comprises:
a main pipeline (11), interconnected with a container storing the electrolyte; and
a branch pipeline (12), arranged between the main pipeline (11) and the flow port of the flow frame (1).

4. The redox flow battery stack according to claim 3, wherein each electrolyte pipeline comprises a plurality of branch pipelines (12), all of which are parallel to each other, and the distance between the branch pipelines (12) is equal to that between the flow frames (1).

5. The redox flow battery stack according to claim 3, wherein the main pipeline (11) is a rigid pipeline or a flexible pipeline.

6. The redox flow battery stack according to claim 5, wherein the branch pipeline (12) is a rigid pipeline or a flexible pipeline.

7. The redox flow battery stack according to claim 5, wherein the main pipeline (11) and/or the branch pipeline (12) are bent.

8. The redox flow battery stack according to claim 1, wherein the liquid inlet and the liquid outlet in each group of flow ports (8, 9) are arranged on the opposite sides of the flow frame (1).

9. The redox flow battery stack according to claim 8, wherein the axis of the liquid inlet and the axis of the liquid outlet are parallel to each other.

10. A redox flow battery system, comprising a redox flow battery stack, an electrolyte container and a pump, the electrolyte container is interconnected with the flow frame (1) of the redox flow battery stack through the pump, wherein, the redox flow battery stack comprises:
flow frames (1);
flow plates (2) arranged inside the flow frames (1);
ion exchange membranes (4) arranged between the flow plates (2) and forming a cavity for accommodating electrolyte with the flow plate (2); and
electrodes (3) arranged inside the cavity; wherein, two groups of flow ports are provided on the sides of the flow frame (1), each group of flow ports (8, 9) comprises: a liquid inlet and a liquid outlets, and the liquid inlet and the liquid outlet in each group of flow ports (8, 9) are provided in the manner of one-to-one correspondence and are interconnected with a corresponding cavity;
the redox flow battery stack further comprises:
electrolyte pipelines, the liquid inlet and the liquid outlet in each group of flow ports (8, 9) respectively have a corresponding electrolyte pipeline and interconnect with the corresponding electrolyte pipeline.

11. The redox flow battery system according to claim 10, wherein the redox flow battery system is an all-vanadium redox flow battery system.

12. The redox flow battery stack according to claim 6, wherein the main pipeline (11) and/or the branch pipeline (12) are bent.

13. The redox flow battery system according to claim 10, wherein the redox flow battery stack further comprises: sealing elements arranged at the connection position between the liquid inlet and the liquid outlet in each group of flow ports (8, 9) and the corresponding electrolyte pipelines.

14. The redox flow battery system according to claim 10, wherein the electrolyte pipeline comprises:
a main pipeline (11), interconnected with a container storing the electrolyte; and
a branch pipeline (12), arranged between the main pipeline (11) and the flow port of the flow frame (1).

15. The redox flow battery system according to claim 14, wherein each electrolyte pipeline comprises a plurality of branch pipelines (12), all of which are parallel to each other, and the distance between the branch pipelines (12) is equal to that between the flow frames (1).

16. The redox flow battery system according to claim 14, wherein the main pipeline (11) is a rigid pipeline or a flexible pipeline.

17. The redox flow battery system according to claim 16, wherein the branch pipeline (12) is a rigid pipeline or a flexible pipeline.

18. The redox flow battery system according to claim 16, wherein the main pipeline (11) and/or the branch pipeline (12) are bent.

19. The redox flow battery system according to claim 10, wherein the liquid inlet and the liquid outlet in each group of flow ports (8, 9) are arranged on the opposite sides of the flow frame (1).

20. The redox flow battery system according to claim 19, wherein the axis of the liquid inlet and the axis of the liquid outlet are parallel to each other.
